(19) United States
(12) Patent Application Publication
(10) Pub. No.: US 2025/0300355 A1
(43) Pub. Date: Sep. 25, 2025

(54) DEVICE AND METHOD FOR READING IDENTIFIERS OF MOVING OBJECTS

(71) Applicant: TÖNNJES ISI PATENT HOLDING GMBH, Delmenhorst (DE)

(72) Inventors: Albertus Jacobus PRETORIUS, Karalee (AU); Stoyan ILIEV, Rosenheim (DE)

(73) Assignee: TÖNNJES ISI PATENT HOLDING GMBH, Delmenhorst (DE)

(21) Appl. No.: 18/860,923

(22) PCT Filed: Jan. 18, 2023
(86) PCT No.: PCT/EP2023/051154

§ 371 Date: Nov. 25, 2024

(30) Foreign Application Priority Data
Apr. 26, 2022 (DE) 10 2022 110 002.2

(51) Int. Cl. H01Q 9/32; G06K 7/10; H01Q 1/32

(52) U.S. Cl. CPC H01Q 9/32; G06K 7/10316; H01Q 1/3225

(57) ABSTRACT

A device and a method for reading transponders of moving objects, by means of which method a plurality of objects are able to be detected simultaneously, regardless of the position and the direction of travel of the objects. This is achieved by virtue of a device for reading UHF RFID signals that are transmitted or reflected by at least one transponder of an identifier having at least one UHF RFID reading apparatus. While the identifier may be a motor vehicle identifier, for example, it is conceivable for the moving object to be a motor vehicle. This at least one reading apparatus for reading the transponder may be located next to, above, or in a roadway on which the object is moving. The at least one reading apparatus has an antenna that is in the form of a monopole antenna.

### DESCRIPTION

The invention relates to a device for reading out UHF RFID signals according to the preamble of claim 1. Furthermore, the invention relates to a method for reading out UHF RFID signals according to the preamble of claim 19.

In order to identify moving objects, such as motor vehicles, for example, it is known practice to assign contactlessly readable transponders to these objects. These transponders have a data memory in which any data regarding the object are able to be stored. In the case of a transponder that is arranged on a motor vehicle, these data may, for example, be information relating to the vehicle, relating to the owner, the insurance, the registration or the like. As is known, these transponders may be fastened to the motor vehicle or to a windscreen in a sticker or a label. Other embodiments make provision for the contactlessly readable transponder to be integrated in an identifier. By way of example, the identifier may be a motor vehicle identifier that is fastened to the vehicle.

Handheld scanners that are used to read the transponder on a stationary object may be used to read the transponders. To this end, the handheld scanners transmit UHF (or NFC) RFID signals that are captured or reflected by the transponders. The information stored in the data memory is able to be read using the signals transmitted or reflected by the transponders. Handheld scanners operate only to a very limited extent, or not at all, when objects are moving. It is known practice for a reading apparatus comprising an antenna to be arranged in the vicinity of a roadway in order to read transponders that are arranged on moving objects or on moving motor vehicles. This reading apparatus may be located in a corresponding device next to or above the roadway. Embodiments are also known, in which the reading apparatus or the antenna is integrated into the roadway surface. It is known practice for UHF antennas to be used in order to read the RFID signals of the transponders.

As long as the moving objects or the motor vehicles are approaching the antenna from a particular direction and with a sufficiently long time interval, the transponders are able to be read at least as reliably as possible. However, if transponders of a plurality of vehicles are intended to be read on a road with a heavy flow of traffic and possibly having multiple lanes, and the vehicles, as may be the case at an intersection, for example, are coming from different directions, the known reading apparatuses reach their technical limits. Reliable reading of the transponders of all the vehicles is therefore no longer achievable. As a result, such antennas become unusable, in particular for detecting vehicles that are subject to tolls.

Proceeding therefrom, the object of the present invention is to provide a device and a method for reading transponders of moving objects, by means of which method a plurality of objects are able to be detected simultaneously, regardless of the position and the direction of travel of the objects.

A device for achieving this object has the features of claim 1. Accordingly, provision is made for a device for reading UHF RFID signals that are transmitted or reflected by at least one transponder of an identifier to have at least one UHF RFID reading apparatus. While the identifier may be a motor vehicle identifier, for example, it is conceivable for the moving object to be a motor vehicle. This at least one reading apparatus for reading the transponder may be located next to, above, or in a roadway on which the object is moving. The invention is characterized in that the at least one reading apparatus has an antenna that is in the form of a monopole antenna. This antenna has an electrically conductive plate element and a first and a second electrically conductive rod element. These rod elements are arranged perpendicularly on the plate element and are galvanically isolated from the plate element. Provision is made for the device according to the invention to be integrated into a roadway surface or to be positioned next to the roadway in the form of at least one column or to be fastened to a cross member above the roadway. By means of this invention, it is possible to read several moving transponders simultaneously or with a short time interval. In this case, signals directed by the antenna are transmitted, captured by the transponders and transmitted or reflected again. The information captured by the antenna is then evaluated by a control unit. It makes no difference where the transponder or object is relative to the antenna. It is therefore possible to detect not only transponders moving toward the antenna counter to the direction of travel of the object, but also transponders moving away from the antenna in the direction of travel of the object. As a result, the invention makes it possible to detect not only transponders that are arranged in the front region of a vehicle, but also those positioned at the rear of the vehicle. It is also possible to detect transponders of objects that pass the reading apparatus laterally, diagonally or transversely.

The possibility of detecting the transponders and therefore the moving objects in any positions relative to the antenna means that the device according to the invention also allows a motion profile of the object or the speed of the object to be ascertained. In particular, on account of the high detection rate and the wide detection horizon, the claimed device is particularly well suited for reading a plurality of transponders that move around the antenna, as is the case, for example, on a road with a heavy flow of traffic or at an intersection. It is conceivable for a plurality of the devices according to the invention to be spaced apart from each other and/or arranged at different positions relative to the roadway in order, for example, to produce a redundant data capturing system or to detect vehicles on a plurality of roads. It is also possible to ascertain information relating to the flow of traffic and the development of traffic by comparing the data recorded at different times.

Provision is preferably made for a voltage source from a feed network to be assigned to the plate element and the rod elements of the reading apparatus or the antenna. UHF RFID signals are able to be applied between the plate element and the rod elements by this voltage source. The signals of the reader are able to be radiated in different spatial directions by way of appropriate control of the voltage. At least almost all of the transponders or objects around the reader are able to be detected on account of this variable radiation characteristic of the antenna.

Provision is in particular made for the first rod element and the second rod element to be arranged at a distance of one quarter to three-quarters of the wavelength of the UHF signals from one another. Both destructive and constructive superposition of the electromagnetic waves transmitted by the two rod elements is achieved as a result of this spacing between the two rod elements. Depending on the amplitude and the phase shift of the signals fed in to both rod elements, the radiation characteristics of the antenna are therefore able to be produced in a manner specifically adapted to the situation.

A further advantageous exemplary embodiment may make provision for the first rod element and the second rod element to be arranged at a distance of half a wavelength from one another. This also provides the possibility of producing specific radiation characteristics of the measuring apparatus by way of corresponding actuation of the rod elements.

Preferably, the invention may also make provision for the feed network to be designed in such a way that UHF RFID signals are able to be applied between the plate element and the second rod element by the voltage source, the phases of said signals being identical to the UHF RFID signals applied between the plate element and the first rod element. Similarly, it is conceivable for the feed network to be designed in such a way that UHF RFID signals are able to be applied between the plate element and the second rod element by the voltage source, the amplitudes of said signals being identical to the UHF RFID signals applied between the plate element and the first rod element. When UHF RFID signals of the same phase and the same amplitude are fed to the two rod elements, a radiation characteristic that has two main lobes is achieved. These main lobes are shifted significantly downward (toward the plate element) with respect to an elliptical torus of a simple monopole antenna. It proves to be particularly advantageous in this case if the diameter of the plate element is able be smaller than 0.5 m in order to achieve the described effect. Higher radiated transmission powers may be used due to the directed radiation characteristic that can thus be achieved. This allows a wider detection range of the reading apparatus, which results in a more reliable detection rate and a higher detectable object speed.

A particularly advantageous exemplary embodiment may make provision for the monopole antenna to have a third and a fourth electrically conductive rod element that are each arranged perpendicular to the plate element, and for the third rod element and the fourth rod element to be arranged at a distance of one quarter to three-quarters of the wavelength of the UHF signals from one another, and for a connecting line between the first and the second rod element and a connecting line between the third and the fourth rod element to each intersect halfway along their extent, and for the two connecting lines to be arranged orthogonally with respect to one another. It is conceivable in this case for the third rod element and the fourth rod element to be arranged at a distance of half a wavelength of the UHF signals from one another.

It is furthermore conceivable for the feed network to be designed in such a way that UHF RFID signals are able to be applied between the plate element and the third rod element, and the plate element and the fourth rod element, by the voltage source, the signals being phase-shifted by 180° with respect to the UHF RFID signals applied between the plate element and the first rod element. Similarly, it is conceivable for the feed network to be designed in such a way that UHF RFID signals are able to be applied between the plate element and the third rod element, and the plate element and the fourth rod element, by the voltage source, the signals being of the same amplitude as the UHF RFID signals applied between the plate element and the first rod element. This arrangement of the rod elements allows UHF RFID transponders to be detected in a plurality of spatial directions. Depending on the requirements, the detection direction is able to be changed with a high detection rate.

In particular, it is conceivable for the perpendicularly arranged rod elements to be in the form of top-loaded monopoles. In this case, provision is made for the rod elements to have, at their ends remote from the plate element, electrically conductive disk elements with a round, elliptical, square or rectangular shape. The length of the rod elements may be shortened as a result, while still ensuring the resonant frequency of the antennas. By way of example, a length of 3 cm would then be sufficient for the rod elements. This measure could further flatten the entire antenna arrangement, which simplifies integration thereof into the device.

A further conceivable exemplary embodiment may make provision for the feed network to be designed in such a way that three of the four rod elements are able to be shorted by the plate element and that UHF RFID signals are able to be applied between the plate element and the remaining rod element by the voltage source. As a result, the three shorted rod elements are used as reflectors for the electromagnetic beams emitted by the remaining rod element. This has the advantage that, for example, for an application on a freeway or expressway, the radiation characteristic may be oriented toward the approaching vehicles for separate lanes and therefore longer detection zones and thus also higher detection speeds are possible.

Furthermore, the invention may make provision for a radiation characteristic of the at least one antenna to be variable, in particular periodically variable, due to the voltage source. This variation allows the device to be used in a manner dependent on the situation and therefore in a highly flexible manner.

A further exemplary embodiment may make provision for the plate element to have, on its plate edge, an electrically conductive border facing the rod elements, and for a height of the border to extend at least to the height of the ends of the rod elements that are remote from the plate element. In addition, provision may be made for the feed network and/or the voltage source to be integrated in a housing arranged on that side of the plate element that is remote from the rod elements. In addition, it is conceivable for the antenna to be integrated into the roadway surface in such a way that that side of the plate element that is facing the rod elements is oriented toward the roadway surface. Provision is preferably made for two, three, four or more reading apparatuses to be arranged next to and/or above and/or on and/or in the route traveled by the moving object in order to detect a plurality of objects simultaneously.

A method for solving the stated problem has the measures of claim 19. Provision is accordingly made to read UHF RFID signals that are transmitted or reflected by at least one transponder of an identifier, in particular a motor vehicle identifier, of a moving object. In this case, the reading is effected by a device as claimed in at least one of claims 1 to 18. The method according to the invention is characterized in that a radiation characteristic of at least one antenna is varied in such a way that it is oriented toward the moving object. This allows each transponder of an object to be detected and read regardless of its position relative to the device. This may be achieved with a high sampling rate by means of the method described herein and by means of the device described.

The invention preferably makes provision for a voltage between a plate element and at least two rod elements of the antenna to be varied in order to change the radiation characteristic. This variation of the voltage allows the radiated characteristic to be radiated in almost any desired directions.

Preferably, it is conceivable for UHF RFID signals from transponders approaching the antenna and/or from transponders moving away from the antenna to be read by varying the radiation characteristic of the at least one antenna. In this case, the radiated characteristic of the at least one antenna is able to be varied in such a way that the UHF RFID signals are able to be read in a 360° range, in particular in a forward, rearward, sideward or diagonal direction, around the antenna.

One preferred exemplary embodiment of the invention is explained in more detail below with reference to the drawing. In the drawing:

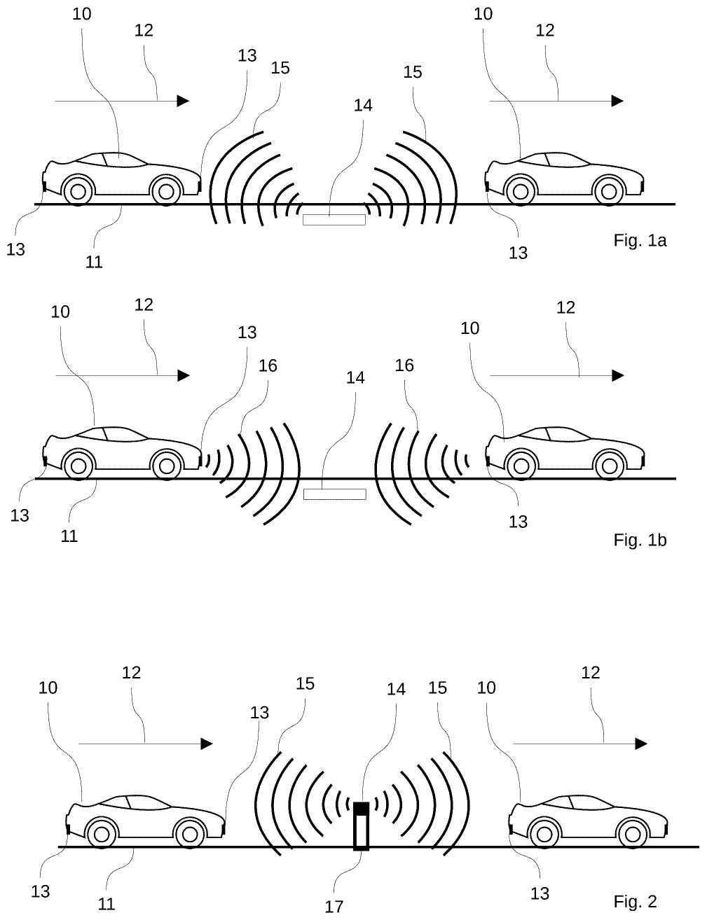

FIG. 1a shows a schematic illustration of a possible exemplary embodiment of the method according to the invention,

FIG. 1b shows a further schematic illustration of the method according to FIG. 1a,

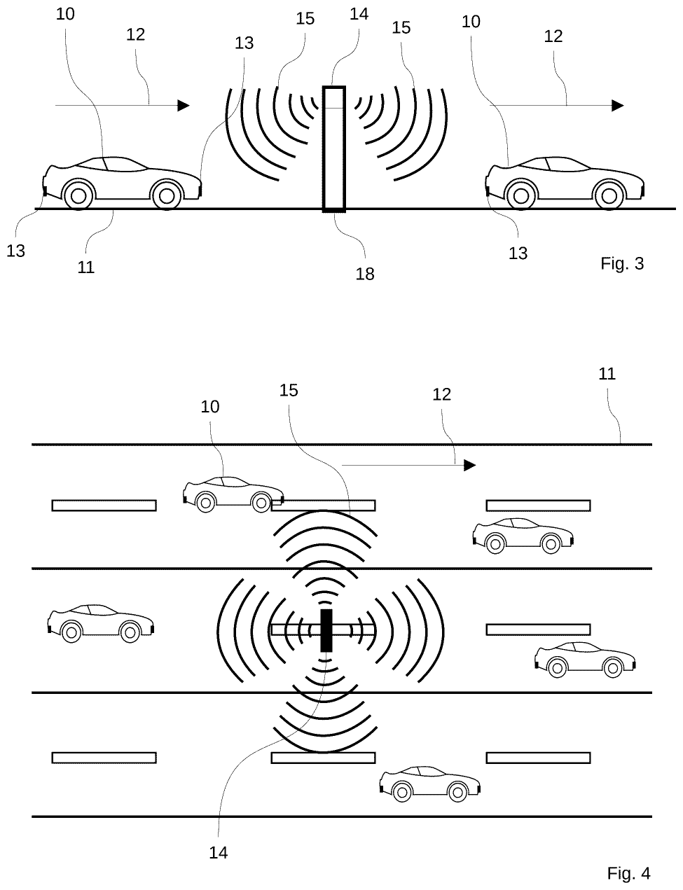

FIG. 2 shows a schematic illustration of a further exemplary embodiment of the method according to the invention,

FIG. 3 shows a schematic illustration of a further exemplary embodiment of the method according to the invention,

FIG. 4 shows a schematic illustration of a further exemplary embodiment of the method according to the invention,

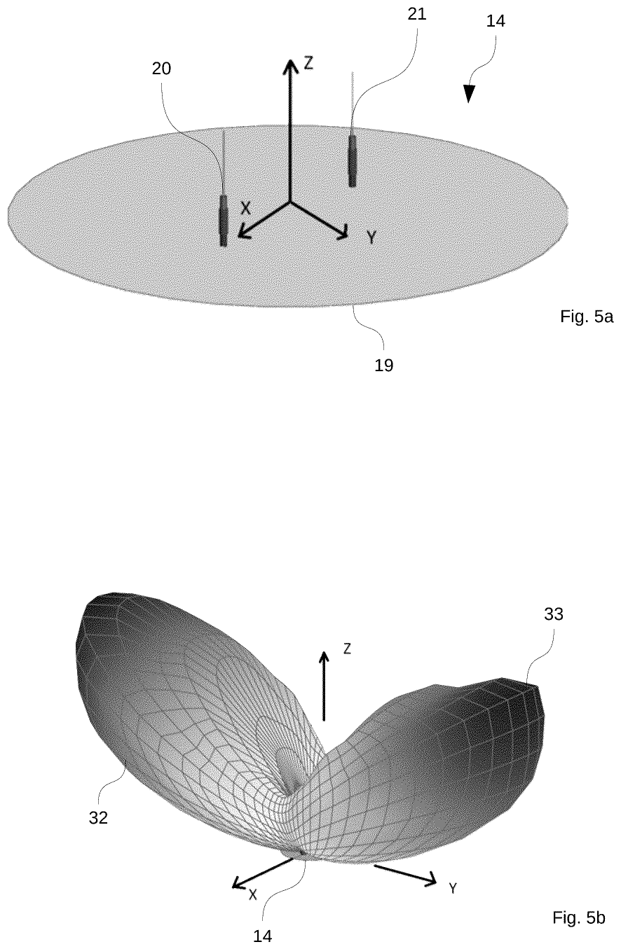

FIG. 5a shows a schematic illustration of the device according to the invention,

FIG. 5b shows an illustration of a radiation characteristic of the device according to FIG. 5a,

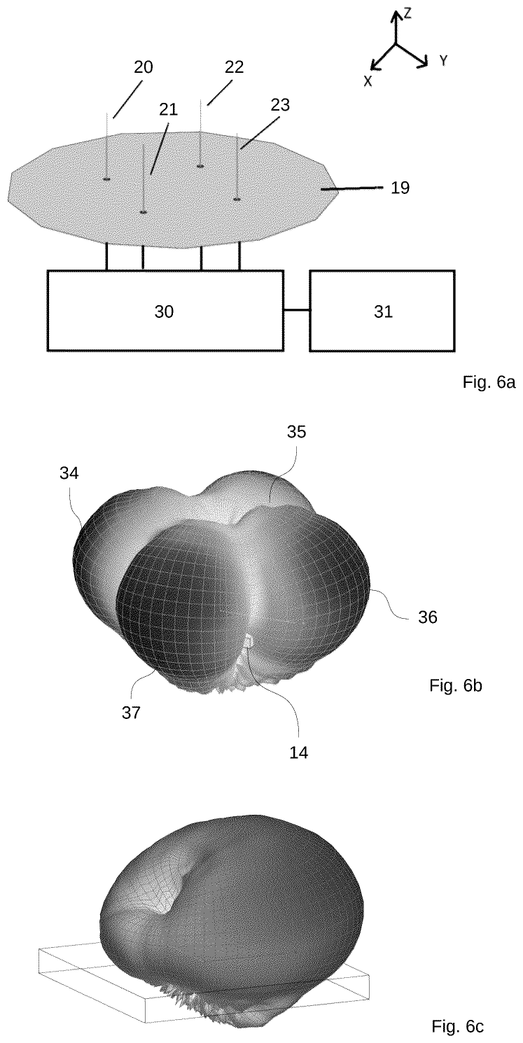

FIG. 6a shows a schematic illustration of a further exemplary embodiment of the device according to the invention,

FIG. 6b shows an illustration of a radiation characteristic of the device according to FIG. 6a,

FIG. 6c shows an illustration of a further radiation characteristic of the device according to FIG. 6a, and

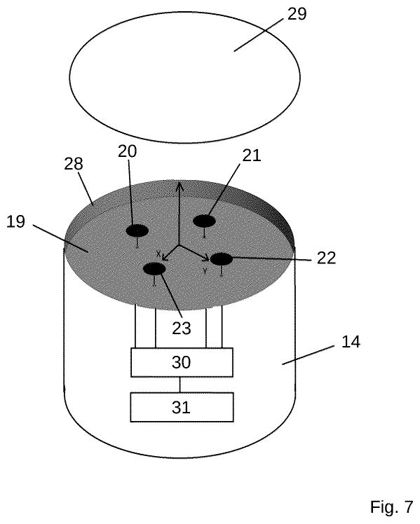

FIG. 7 shows a schematic illustration of a further exemplary embodiment of the device according to the invention.

By way of the method according to the invention, it is possible to read a plurality of transponders of moving objects regardless of their direction of movement. The moving objects may be motor vehicles. By way of example, the transponders may be located on or in the license plate of the motor vehicle or in a windshield label. In addition, it is conceivable for the transponders to be located on the tires of the vehicle, under the vehicle, or at a different location on the vehicle. The data stored in the transponders and to be read may be related to a toll system, a parking system, fuel applications or be used to identify the vehicle or the vehicle owner. In order to contactlessly read these data, the invention provides a device comprising a reading apparatus that is assigned to a roadway on which the motor vehicles move. A plurality of conceivable embodiments are shown in the figures. However, it should be expressly pointed out that the invention is not restricted to the exemplary embodiments shown here. On the contrary, it is intended for the scope of protection to also comprise further embodiments.

FIG. 1a shows two motor vehicles 10 that are moving on a roadway 11 in a direction of travel 12. The motor vehicles 10 each have a transponder 13 on a front region and a rear region. By way of example, these transponders 13 may be integrated in a license plate of the motor vehicle 10. Alternatively, it is also conceivable for the transponders 13 to be fastened at a different location on the motor vehicle 10 or to a different component of the motor vehicle 10, such as the wheels, for example.

In the exemplary embodiment of the method according to the invention that is shown in FIG. 1a, a reading apparatus 14 is integrated into the roadway 11 for transmitting and receiving UHF RFID signals. This reading apparatus 14 has at least one antenna, a control apparatus 30 and an energy supply or a feed network 31. By virtue of the reading apparatus 14 being integrated into the roadway 11 or into the surface of the roadway 11, it is located in direct proximity to the motor vehicles 10 without obstructing the vehicles 10. As shown highly schematically in FIG. 1a, outgoing signals 15 are transmitted by the reading apparatus 14. These outgoing signals 15 are able to be focused or oriented by the control apparatus 30 in such a way that they are oriented to the detected transponders 13. In this case, both transponders 13 of motor vehicles 10 approaching the reading apparatus 14 and transponders 13 of motor vehicles 10 moving away from the reading apparatus 14, as viewed in the direction of travel 12, are able to be detected. The outgoing signals 15 are either reflected by the transponders 13 or the transponders 13, which may be active or passive RFID chips, transmit incoming signals 16 (FIG. 1b). These reflected or incoming signals 16 are captured and evaluated by the reading apparatus 14. The information stored in the data memories of the transponders 13 may be captured by means of the evaluation signals.

In addition to the exemplary embodiment shown in FIGS. 1a and 1b, it is also conceivable for the reading apparatus 14 to be arranged in a column 17 next to the roadway 11 (FIG. 2). The transmitting and receiving operating principle is identical to the exemplary embodiment described above. The transmission or reception horizon of the reading apparatus 14 may be enlarged by positioning the reading apparatus 14 in a column 17.

Finally, it is also conceivable for the reading apparatus 14 to be accommodated in a cross member 18 spanning the roadway 11. This allows both a large transmission or reception horizon of the reading apparatus 14 and the advantageous proximity of the reading apparatus 14 to the motor vehicles 10.

By means of the method described herein or by means of the reading apparatus 14, it is possible to detect motor vehicles 10 not only on a roadway 11, but also on a plurality of adjacent roadways 11. As schematically shown in FIG. 4, the outgoing signals 15 are able to be transmitted not only parallel to the roadway 11 in the direction of travel 12, but also perpendicular thereto, with the result that a plurality of motor vehicles 10 are also able to be detected on other roadways 11. This proves to be very advantageous in particular on roads with a heavy flow of traffic and at intersections. Similarly, the incoming signals, which are not shown in FIG. 4, from vehicles 10 that are located on different roadways 11 are able to be captured. Continuously capturing signals makes it possible not only for the reading apparatus 14 to read information about the motor vehicles 10, but also to detect the speed of said motor vehicles.

FIG. 5a shows a possible embodiment of the reading apparatus 14 for UHF RFID signals or an antenna arrangement. This antenna arrangement is distinguished by the fact that two electrically conductive rod elements 20, 21 are arranged on a plate element 19 perpendicular to the plate element 19. An essential feature of this arrangement is that the two rod elements 20, 21 have a distance of half the wavelength of the UHF signals. In the embodiment shown in FIG. 5a, the plate element 19 is in the xy-plane and the two rod elements 20, 21 are oriented parallel to the z-axis.

A feed network 31 for supplying electrical energy to the reading apparatus 14 is designed in such a way that UHF RFID signals are able to be applied between the plate element 19 and the second rod element 21 by a voltage source, the phase and/or amplitude of said signals being identical to the UHF RFID signals applied between the plate element 19 and the first rod element 20. With identical phase and amplitude, the radiation characteristic shown in FIG. 5b is obtained for the reading apparatus 14 shown in FIG. 5a. This radiation characteristic has two main lobes 32, 33, which are shifted toward the plate element 19. This characteristic arises as a result of components of the electric fields in the y-direction of both electromagnetic beams emitted by the rod elements 20, 21 being superposed constructively and the components of the electric fields in the x-direction being superposed destructively.

FIG. 6a shows a further exemplary embodiment of the reading apparatus 14 according to the invention. In addition to the first and the second rod element 20, 21, the antenna arrangement has a third and a fourth rod element 22, 23, which are also oriented perpendicular to the plate element 19 and therefore parallel to the rod elements 20, 21. These two rod elements 22, 23 are also designed to be electrically conductive. The third rod element 22 and the fourth rod element 23 are arranged at a distance of half the wavelength of the UHF signals from one another. A connecting line between the first and the second rod element 20, 21 and a connecting line between the third and the fourth rod element 22, 23 each intersect halfway along their extent, wherein both connecting lines are arranged orthogonally with respect to one another. The four rod elements 20-23 thus form the corner points of a square, wherein the diagonal connecting the opposite corner points has a length of half the wavelength of the UHF signals.

In this exemplary embodiment, the feed network 31 is designed in such a way that UHF RFID signals are able to be applied between the plate element 19 and the third rod element 22, and the plate element 19 and the fourth rod element 23, by the voltage source, the signals being phase-shifted by 180° with respect to, and/or of the same amplitude as, the UHF RFID signals applied between the plate element 19 and the first rod element 20. With a phase shift of 180° and the same amplitudes in each case, the radiation characteristic shown in FIG. 6b is obtained for the antenna arrangement shown in FIG. 6a. This radiation characteristic has four main lobes 34 to 37. In this case, the feed network 31 may also be designed in such a way that three of the four rod elements 20-23 are able to be shorted by the plate element 19 and that the UHF RFID signals are able to be applied between the plate element 19 and the remaining rod element by the voltage source. FIG. 6c shows the resulting radiation characteristic of the reading apparatus 14.

FIG. 7 shows a further exemplary embodiment of the reading apparatus 14 according to the invention. The perpendicularly arranged rod elements 20-23 here are in the form of top-loaded monopoles. In the embodiment shown, to this end, the rod elements 20-23 have, at their ends remote from the plate element 19, electrically conductive disk elements 24-27. The disk elements 24-27 shown are round. However, it is also conceivable for the disk elements 24-27 to be elliptical, square, rectangular or the like.

Furthermore, the plate element 19 has, on a plate edge, an electrically conductive border 28 facing the rod elements 20-23. A height of the border 28 extends at least to the height of the ends of the rod elements 20-23 that are remote from the plate element 19. However, the border 28 may also extend beyond the ends of the rod elements 20-23 that are remote from the plate element 19. The feed network 31 and the voltage source are integrated in a housing that is arranged on that side of the plate element 19 that is remote from the rod elements 20-23. Optionally, the antenna arrangement may be covered with an electrically non-conductive cover 29 so that the rod elements 20-23 are protected from mechanical and chemical influences.

The antenna arrangement shown here is integrated into the roadway 11 in such a way that that side of the plate element 19 that is facing the rod elements 20-23 is oriented toward the road surface.

Furthermore, the invention is not restricted to the first rod element 20 and the second rod element 21 being arranged at a distance of half a wavelength of the UHF signals from one another. In further embodiments, the first rod element 20 and the second rod element 21 and/or the third rod element 22 and the fourth rod element 23 are arranged at a distance of one quarter to three-quarters of the wavelength of the UHF signals from one another.

### LIST OF REFERENCE SIGNS

10 Motor vehicle
11 Roadway
12 Direction of travel
13 Transponder
14 Reading apparatus
15 Outgoing signal
16 Incoming signal
17 Column
18 Cross member
19 Plate element
20 Rod element
21 Rod element
22 Rod element
23 Rod element
24 Disk element
25 Disk element
26 Disk element
27 Disk element
28 Border
29 Cover
30 Control apparatus
31 Feed network
32 Main lobe
33 Main lobe
34 Main lobe
35 Main lobe
36 Main lobe
37 Main lobe

1. A device for reading UHF RFID signals that are transmitted or reflected by at least one transponder of an identifier of a moving object, with at least one UHF RFID reading apparatus, wherein the reading apparatus has at least one antenna, and wherein the at least one reading apparatus is integrated next to and/or above and/or on a route traveled by the moving object, and/or in a surface on the route, wherein an antenna of the at least one reading apparatus is in the form of a monopole antenna comprising an electrically conductive plate element and a first and a second electrically conductive rod element, wherein the rod elements are arranged perpendicularly on the plate element and the plate element and the rod elements are galvanically isolated from one another.

2. The device for reading UHF RFID signals as claimed in claim 1, wherein a voltage source from a feed network of the UHF RFID reader is assigned to the plate element and the rod elements in order to apply UHF RFID signals between the plate element and the rod elements.

3. The device for reading UHF RFID signals as claimed in claim 1, wherein the first rod element and the second rod element are arranged at a distance of one quarter to three-quarters of the wavelength of the UHF signals from one another.

4. The device for reading UHF RFID signals as claimed in claim 1, wherein the first rod element and the second rod element are arranged at a distance of half a wavelength of the UHF signals from one another.

5. The device for reading UHF RFID signals as claimed in claim 1, wherein the feed network is designed in such a way that UHF RFID signals are able to be applied between the plate element and the second rod element by the voltage source, the phases of said signals being identical to the UHF RFID signals applied between the plate element and the first rod element.

6. The device for reading UHF RFID signals as claimed in claim 1, wherein the feed network is designed in such a way that UHF RFID signals are able to be applied between the plate element and the second rod element by the voltage source, the amplitudes of said signals being identical to the UHF RFID signals applied between the plate element and the first rod element.

7. The device for reading UHF RFID signals as claimed in claim 1, wherein the monopole antenna has a third and a fourth electrically conductive rod element that are each arranged perpendicular to the plate element, and in that the third rod element and the fourth rod element are arranged at a distance of one quarter to three-quarters of the wavelength of the UHF signals from one another, and in that a connecting line between the first and the second rod element and a connecting line between the third and the fourth rod element each intersect halfway along their extent, and in that the two connecting lines are arranged orthogonally with respect to one another.

8. The device for reading UHF RFID signals as claimed in claim 7, wherein the third rod element and the fourth rod element are arranged at a distance of half a wavelength of the UHF signals from one another.

9. The device for reading UHF RFID signals as claimed in claim 7, wherein the feed network is designed in such a way that UHF RFID signals are able to be applied between the plate element and the third rod element, and the plate element-and the fourth rod element, by the voltage source, the signals being phase-shifted by 180° with respect to the UHF RFID signals applied between the plate element-and the first rod element.

10. The device for reading UHF RFID signals as claimed in claim 7, wherein the feed network is designed in such a way that UHF RFID signals are able to be applied between the plate element and the third rod element, and the plate element and the fourth rod element, by the voltage source, the signals being of the same amplitude as the UHF RFID signals applied between the plate element and the first rod element.

11. The device for reading UHF RFID signals as claimed in claim 1, wherein the perpendicularly arranged rod elements are in the form of top-loaded monopoles.

12. The device for reading UHF RFID signals as claimed in claim 1, wherein the rod elements have, at their ends remote from the plate element, electrically conductive disk elements with a round, elliptical, square or rectangular shape.

13. The device for reading UHF RFID signals as claimed in claim 1, wherein the feed network is designed in such a way that three of the four rod elements are able to be shorted by the plate element and that the UHF RFID signals are able to be applied between the plate element and the remaining rod element by the voltage source.

14. The device for reading UHF RFID signals as claimed in claim 1, wherein a radiation characteristic and/or a radiation direction of the at least one antenna are/is variable, due to the voltage source.

15. The device for reading UHF RFID signals as claimed in claim 1, wherein the plate element has, on its plate edge, an electrically conductive border facing the rod elements, and in that a height of the border extends at least to the height of the ends of the rod elements that are remote from the plate element.

16. The device for reading UHF RFID signals as claimed in claim 1, wherein the feed network and/or the voltage source are/is integrated in a housing arranged on that side of the plate element that is remote from the rod elements.

17. The device for reading UHF RFID signals as claimed in claim 1, wherein the antenna is integrated into the roadway surface in such a way that that side of the plate element that is facing the rod elements is oriented toward the surface of the roadway.

18. The device for reading UHF RFID signals as claimed in claim 1, wherein two, three, four or more reading apparatuses are arranged next to and/or above and/or on and/or in the route traveled by the moving object in order to detect a plurality of objects simultaneously.

19. A method for reading UHF RFID signals that are transmitted or reflected by at least one transponder of an identifier of a moving object, comprising a device as claimed in claim 1, wherein a radiation characteristic of at least one antenna is varied in such a way that it is oriented toward the moving object.

20. The method for reading UHF RFID signals as claimed in claim 19, wherein a voltage between a plate element and at least two rod elements of the antenna is varied in order to change the radiation characteristic.

21. The method for reading UHF RFID signals as claimed in claim 19, wherein UHF RFID signals from transponders approaching the antennas and/or from transponders moving away from the antenna are read by varying the radiation characteristic of the at least one antenna.

22. The method for reading UHF RFID signals as claimed in claim 19, wherein the radiation characteristic of the at least one antenna is varied in such a way that UHF RFID signals are read in a 360° range, around the antenna.
